(19) United States
(12) Patent Application Publication
(10) Pub. No.: US 2022/0129970 A1
(43) Pub. Date: Apr. 28, 2022

(54) COMMODITY DATA PROCESSING APPARATUS AND CONTROL METHOD BY THE SAME

(71) Applicant: TOSHIBA TEC KABUSHIKI KAISHA, Tokyo (JP)

(72) Inventors: Xiaozhou WANG, Tagata Shizuoka (JP); Takashi IKEUCHI, Kawasaki Kanagawa (JP); Hiroshi NISHIKAWA, Izunokuni Shizuoka (JP); Kentaro OKAMOTO, Izunokuni Shizuoka (JP)

(21) Appl. No.: 17/568,934

(22) Filed: Jan. 5, 2022

Related U.S. Application Data
(63) Continuation of application No. 16/691,773, filed on Nov. 22, 2019.

(30) Foreign Application Priority Data
Jan. 15, 2019 (JP) 2019-004582

(51) Int. Cl. G06Q 30/06; G06Q 10/08

(52) U.S. Cl. CPC G06Q 30/0635; G06Q 10/087; G06Q 30/0641

(57) ABSTRACT

A commodity data processing apparatus includes a communication interface connected to a network, and a processor that executes a program that includes an acquiring module that acquires order information relating to an ordered commodity, a specifying module that identifies a purchaser who comes to a store, and a notifying module that notifies the identified purchaser through the communication interface that the ordered commodity is in stock at the store if the ordered commodity is in stock at the store.

### CROSS-REFERENCE TO RELATED APPLICATIONS

This application is a continuation of U.S. patent application Ser. No. 16/691,773, filed on Nov. 22, 2019, which is based upon and claims the benefit of priority from Japanese Patent Application No. 2019-004582, filed on Jan. 15, 2019, the entire contents of each of which are incorporated herein by reference.

### FIELD

Embodiments described herein relate generally to a commodity data processing apparatus and a control method for enabling a computer to function as a commodity data processing apparatus.

### BACKGROUND

In recent years, a so-called net supermarket sales system has been widely used, in which an actual store such as a supermarket opens a virtual store on the Internet to sell a commodity sold in the actual store in the virtual store as well. Furthermore, a so-called omni-channel mechanism has been established. The omni-channel mechanism manages inventory information, sales information, purchaser information, etc. of the commodity in an integrated manner in the actual store and the virtual store such that a purchaser can order or purchase the commodity without being aware of whether the store is the actual store or the virtual store.

### BRIEF DESCRIPTION OF THE DRAWINGS

FIG. 1 is a diagram schematically illustrating an overall configuration of a sales system in which an actual store and a virtual store are integrated with each other;

FIG. 2 is a diagram schematically illustrating a main data structure of order commodity data;

FIG. 3 is a block diagram illustrating a circuit configuration of main portions of an information terminal;

FIG. 4 is a block diagram illustrating a circuit configuration of main portions of an actual store server;

FIG. 5 is a diagram schematically illustrating a shopping basket memory;

FIG. 6 is a flowchart depicting a main procedure of an information processing performed by a processor of the information terminal according to a terminal program;

FIG. 7 is a flowchart depicting a main procedure of the information processing performed by the processor of the information terminal according to the terminal program;

FIG. 8 is a flowchart depicting a main procedure of the information processing performed by the processor of the information terminal according to the terminal program;

FIG. 9 is a flowchart depicting a procedure of a login command reception processing performed by a processor of the actual store server;

FIG. 10 is a flowchart depicting a procedure of a commodity registration reception processing performed by the processor of the actual store server;

FIG. 11 is a flowchart depicting a procedure of a settlement confirmation command reception processing performed by the processor of the actual store server;

FIG. 12 is a flowchart depicting a procedure of a settlement execution command reception processing performed by the processor of the actual store server;

FIG. 13 is a flowchart depicting a procedure of a settlement cancel command reception processing performed by the processor of the actual store server;

FIG. 14 is a flowchart depicting a procedure of a scanner command reception processing performed by the processor of the actual store server;

FIG. 15 is a diagram schematically illustrating a registration screen with which a notification operation is performed;

FIG. 16 is a diagram schematically illustrating a purchase forgetting confirmation image;

FIG. 17 is a diagram schematically illustrating a settlement guide screen;

FIG. 18 is a diagram schematically illustrating another registration screen with which the notification operation is performed; and

FIG. 19 is a flowchart depicting a main procedure of the login command reception processing performed by the processor of the actual store server in regard to another example shown in FIG. 18.

### DETAILED DESCRIPTION

In accordance with an embodiment, a commodity data processing apparatus includes a communication interface connected to a network, and a processor that executes a program that includes an acquiring module that acquires order information relating to an ordered commodity, a specifying module that identifies a purchaser who comes to a store, and a notifying module that notifies the identified purchaser through the communication interface that the ordered commodity is in stock at the store if the ordered commodity is in stock at the store.

Hereinafter, an embodiment of a commodity data processing apparatus capable of easily operating in such a sales form that an order is placed in a virtual store and a commodity is purchased after being found in an actual store is described with reference to the accompanying drawings. In the embodiment described herein, the actual store of a system in which a purchaser operates an information terminal mounted on a shopping cart to register a commodity purchased by the purchaser in the actual store, opens the virtual store on the Internet.

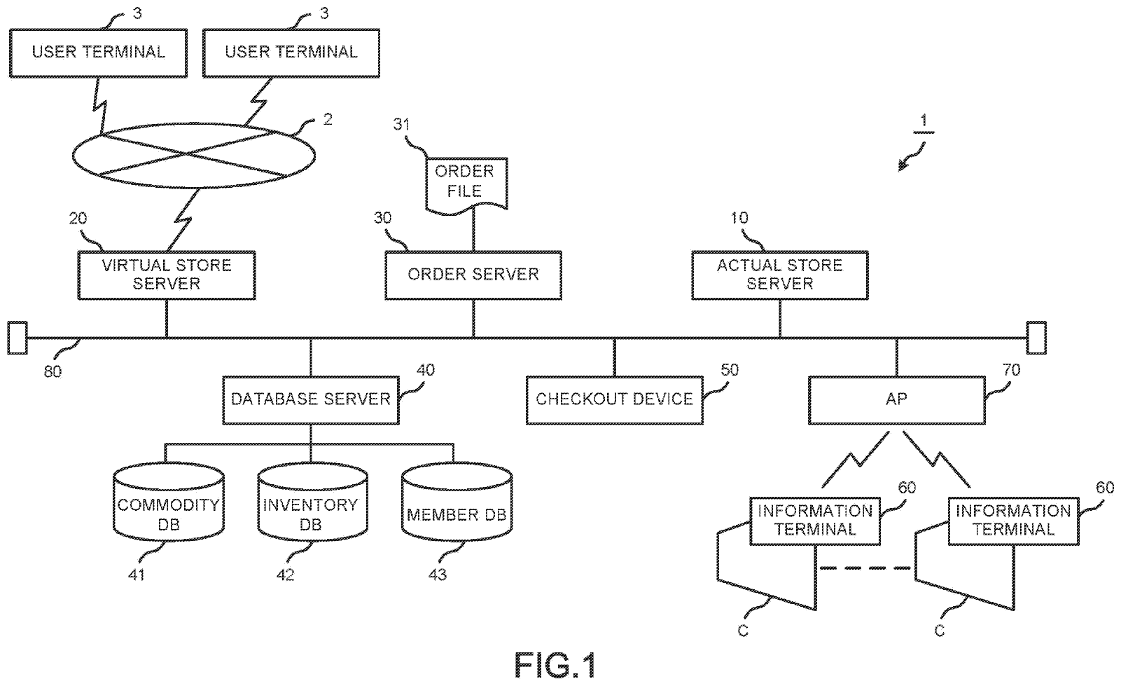

FIG. 1 is a diagram schematically illustrating an overall configuration of a sales system 1 in which an actual store (e.g., a brick-and-mortar store) and a virtual store are integrated with each other. The sales system 1 includes an actual store server 10, a virtual store server 20, an order server 30, a database server 40, a checkout device 50, an information terminal 60 and an access point (AP) 70. The sales system 1 further includes a network 80. The network 80 connects the actual store server 10, the virtual store server 20, the order server 30, the database server 40, the checkout device 50 and the access point 70 in a communication enabled manner. The network 80 is, for example, a LAN (Local Area Network).

The actual store server 10, the checkout device 50, the information terminal 60 and the access point 70 are provided in the actual store. The virtual store server 20 and the order server 30 are necessary for the virtual store. The database server 40 is commonly used in the actual store and the virtual store.

The information terminal 60 enables a purchaser (e.g., a customer) to input data relating to registration of a purchased commodity by himself/herself in the actual store. The information terminal 60 is mounted on a shopping cart C in the actual store. Hereinafter, the shopping cart C is simply referred to as the cart C. The cart C is an example of a carrier for transporting a purchased commodity for a purchaser who is using the cart C.

The information terminal 60 is provided with a wireless unit. The information terminal 60 establishes wireless communication with the access point 70. The access point 70 relays communication between the information terminal 60 and various devices connected to the network 80 including the actual store server 10, the virtual store server 20, the order server 30, the database server 40 and the checkout device 50. Although only one access point 70 is shown in FIG. 1, two or more access points may be provided depending on a size of the store.

The actual store server 10 supports operations from sales to settlement of the commodity in the actual store. For example, the actual store server 10 cooperates with the information terminal 60 to provide a support to make the information terminal 60 to function as a POS (Point Of Sales) terminal. The actual store server 10 cooperates with the checkout device 50 to provide a support to settle one transaction with the purchaser.

The virtual store server 20 supports operations from order to settlement of the commodity in the virtual store. The virtual store server 20 is connected to the Internet 2 on which a so-called virtual store which is a website for commodity sales is opened. The virtual store server 20 receives an order of a commodity from the user terminal 3 that accesses the virtual store through the Internet 2. The user terminal 3 is an electronic device operated by a user who is a customer of the virtual store, such as a personal computer, a tablet terminal, a smartphone or the like, for example. When the virtual store server 20 receives an order of the commodity sold in the virtual store via the user terminal 3, the virtual store server 20 transmits data indicating contents of the order to the order server 30.

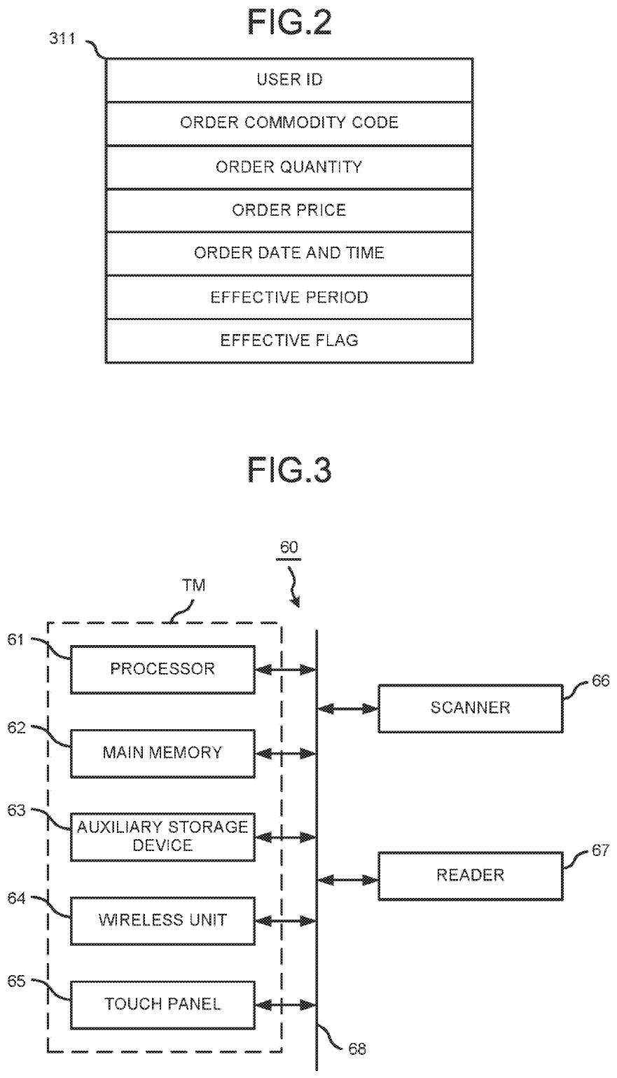

The order server 30 is configured for managing the order received in the virtual store. The order server 30 generates an order commodity data 311 (refer to FIG. 2) based on the data indicating contents of the order received from the virtual store server 20. The order server 30 stores an order file 31, and registers the order commodity data 311 in the order file 31. The order file 31 is an example of a storage module capable of storing a plurality of order commodity data 311. The order file 31 may be stored in a storage device provided in the order server 30 or in an external storage device connected to the order server 30.

FIG. 2 is a diagram schematically illustrating a main data structure of the order commodity data 311. As shown in FIG. 2, the order commodity data 311 includes data items such as a user ID, an order commodity code, order quantity, an order price, order date and time, an effective period, an effective flag and the like. The user ID is a unique code assigned to each purchaser for individually identifying the purchaser who orders the commodity. The purchaser who is a customer of the virtual store performs member registration in advance on the website of the virtual store. In response to the member registration, a new user ID is issued by a membership server (not shown) and is notified to the purchaser.

The order commodity code is used to identify the commodity ordered in the virtual store. Each commodity sold in the virtual store or the actual store is assigned with an individual unique commodity identification code. The commodity identification code is a unique value regardless of sales channels such as the virtual store and the actual store. In other words, the commodity identification code of the commodity sold in the virtual store is the same as that of the same commodity sold in the actual store.

The order quantity is the number of commodities ordered in the virtual store. The order price is a price of the commodity at a time point the order is received in the virtual store. The order date and time is a date and time at which the order is received in the virtual store.

The effective period is a period in which the order commodity data 311 is effective. If the period set as the effective period elapses from the order date and time, the order commodity data 311 becomes ineffective. The effective period may be different for each commodity, or may be different for each department that classifies the commodities. The effective period may be set commonly for all commodities.

The effective flag is 1-bit data for identifying whether or not the order commodity data 311 is effective. In the present embodiment, the effective flag is set to “1” when the order commodity data 311 is effective, and the effective flag is set to “0” when the order commodity data 311 is ineffective.

With reference to the description of FIG. 1, the order server 30 examines the order commodity data 311 registered in the order file 31 after closing of the actual store every business day. The order server 30 calculates the number of elapsed days from the order date and time to the current date for all the order commodity data 311 in which the value of the effective flag is “1” indicating that the order commodity data 311 is effective. Then, the order server 30 changes the effective flag included in the order commodity data 311 for which the number of elapsed days reaches the effective period to the value “0” indicating that the order commodity data 311 is ineffective. The order server 30 examines the order commodity data 311 registered in the order file 31 every predetermined period, for example, every week. The order server 30 deletes, from the order file 31, the order commodity data 311 in which the value of the effective flag is “0” indicating that the order commodity data 311 is ineffective.

The database server 40 is configured for managing a database such as a commodity database 41, an inventory database 42 and a member database 43. The commodity database 41 stores data relating to sales of various commodities sold in the actual store or the virtual store in a form of a commodity record created for each commodity. The commodity record includes data items such as a commodity identification code, a price, a commodity name and the like. The price refers to a sales price of the commodity at the current time point. The price in the actual store and the price in the virtual store may be the same or different. For example, although there is only one type of the price stored in the commodity database 41, the actual store server 10 or the virtual store server 20 may change the sales price by increasing or discounting the price.

The inventory database 42 stores data relating to an inventory state of various commodities sold in the actual store or the virtual store in a form of an inventory record created for each commodity. The inventory record includes data items such as a commodity identification code, an inventory quantity and the like. The inventory quantity refers to the total number of commodities sold in the actual store. In the virtual store, a commodity can be ordered even if it is out of stock.

The member database 43 stores a member record created for each purchaser who performs a member registration to become a customer of the virtual store. The member record includes a unique user ID assigned to each purchaser to uniquely identify the purchaser.

The checkout device 50 enables a store clerk or the purchaser to perform a settlement on the purchased commodity in the actual store. The checkout device 50 is a known self-service type POS terminal. The checkout device 50 may be a known face-to-face type POS terminal.

FIG. 3 is a block diagram illustrating a circuit configuration of main portions of the information terminal 60. The information terminal 60 includes a processor 61, a main memory 62, an auxiliary storage device 63, a wireless unit 64, a touch panel 65, a scanner 66, a reader 67 and a system transmission line 68. The system transmission line 68 includes an address bus, a data bus, a control signal line and the like. In the information terminal 60, the processor 61, the main memory 62, the auxiliary storage device 63, the wireless unit 64, the touch panel 65, the scanner 66 and the reader 67 are connected to the system transmission line 68. In the information terminal 60, a computer is configured by the processor 61, the main memory 62, the auxiliary storage device 63, and the system transmission line 68 for connecting those.

The processor 61 acts as a central component of the computer. The processor 61 executes an operating system or an application program to control each section to realize various functions of the information terminal 60. The processor 61 is, for example, a CPU (Central Processing Unit).

The main memory 62 acts as a main storage component of the computer. The main memory 62 includes a non-volatile memory area and a volatile memory area. The main memory 62 stores the operating system or the application program in the non-volatile memory area. The application program includes a terminal program described below. The main memory 62 may store data necessary for the processor 61 to execute a processing for controlling each section in the non-volatile memory area or the volatile memory area in some cases. The main memory 62 uses the volatile memory area as a work area in which data is appropriately rewritten by the processor 61. The non-volatile memory area is, for example, a ROM (Read Only Memory). The volatile memory area is, for example, a RAM (Random Access Memory).

The auxiliary storage device 63 acts as an auxiliary storage component of the computer. The auxiliary storage device 63 may be, for example, an EEPROM (Electric Erasable Programmable Read-Only Memory), an HDD (Hard Disk Drive), an SSD (Solid State Drive) or the like. The auxiliary storage device 63 stores data used by the processor 61 to perform various processing and data generated in a processing executed by the processor 61. The auxiliary storage device 63 may store the application program including the terminal program described below in some cases.

The wireless unit 64 is, for example, a wireless interface circuit, and establishes data wireless communication with the access point 70 in conformity to a wireless communication protocol.

The touch panel 65 includes an input device and a display device of the information terminal 60. The touch panel 65 detects a touch position on a displayed image, and outputs touch position information to the processor 61.

The scanner 66 reads a code symbol such as a barcode or a two-dimensional data code attached to a commodity. The code symbol indicating the commodity identification code of the commodity is attached to the commodity. The scanner 66 outputs data of the read code symbol to the processor 61. The scanner 66 may read the code symbol by scanning with a laser beam, or may read the code symbol from an image captured by an image capturing device.

The reader 67 reads data recorded on a recording medium, and outputs the read data to the processor 61. The reader 67 is a magnetic card reader in a case in which the recording medium is a magnetic card, or is an IC card reader in a case in which the recording medium is a contact type IC card. In the case of a recording medium using a RFID (Radio Frequency Identification), for example, a non-contact type IC card or a smartphone, the reader 67 is an RFID reader.

In the information terminal 60 provided with the circuit components as described above, the processor 61, the main memory 62, the auxiliary storage device 63, the wireless unit 64 and the touch panel 65 are constituted through a tablet terminal TM. The information terminal 60 is configured by electrically connecting the scanner 66 and the reader 67 to the tablet terminal TM.

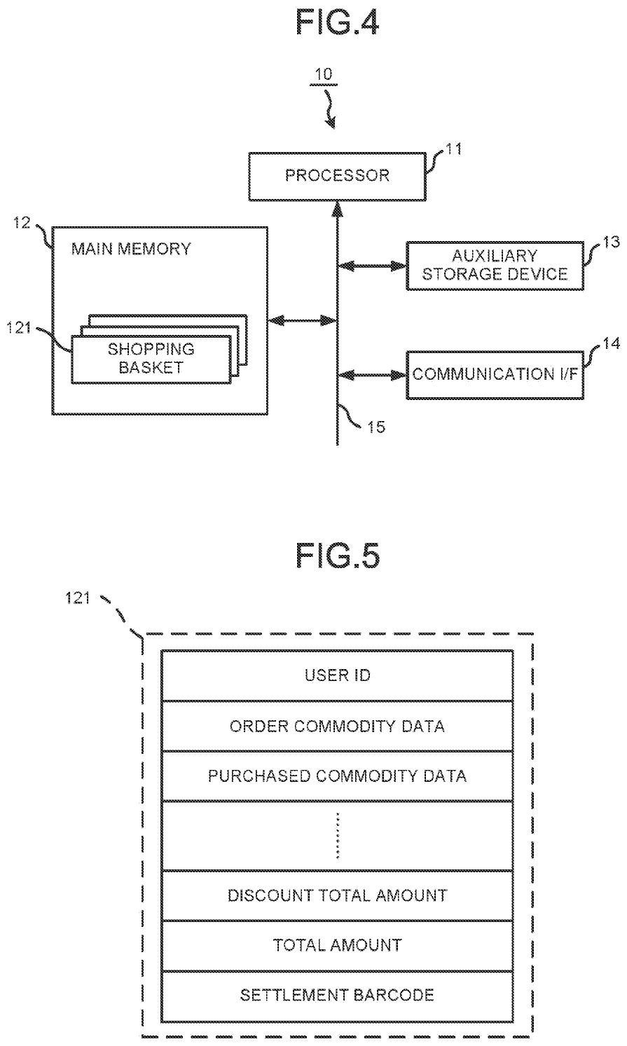

FIG. 4 is a block diagram illustrating a circuit configuration of main portions of the actual store server 10. The actual store server 10 includes a processor 11, a main memory 12, an auxiliary storage device 13, a communication interface 14 and a system transmission line 15. The system transmission line 15 includes an address bus, a data bus, a control signal line and the like. In the actual store server 10, the processor 11, the main memory 12, the auxiliary storage device 13 and the communication interface 14 are connected to the system transmission line 15. In the actual store server 10, a computer is configured by the processor 11, the main memory 12, the auxiliary storage device 13, and the system transmission line 15 for connecting these elements to each other.

The processor 11 acts as a central component of the computer. The processor 11 executes an operating system or an application program to control each section to realize various functions of the actual store server 10. The processor 11 is, for example, a CPU.

The main memory 12 acts as a main storage component of the computer. The main memory 12 includes a non-volatile memory area and a volatile memory area. The main memory 12 stores the operating system or the application program in the non-volatile memory area. The application program includes a control program described below. The main memory 12 may store data necessary for the processor 11 to execute a processing for controlling each section in the non-volatile memory area or the volatile memory area in some cases. The main memory 12 uses the volatile memory area as a work area in which data is appropriately rewritten by the processor 11. The non-volatile memory area is, for example, a ROM. The volatile memory area is, for example, a RAM.

The auxiliary storage device 13 acts as an auxiliary storage component of the computer. The auxiliary storage device 13 may be, for example, an EEPROM, an HDD, an SSD or the like. The auxiliary storage device 13 stores data used by the processor 11 to perform various processing and data generated in a processing executed by the processor 11. The auxiliary storage device 13 may store the application program including a control program described below.

The communication interface 14 is connected to the network 80. The communication interface 14 establishes data communication with other devices connected via the network 80 in conformity with a communication protocol under the control of the processor 11.

In the actual store server 10 having such a configuration, a part of the volatile memory area of the main memory 12 is used as an area for creating a shopping basket memory 121. The actual store server 10 can create a plurality of shopping basket memories 121 in the area.

FIG. 5 is a diagram schematically illustrating the shopping basket memory 121. As shown in FIG. 5, the shopping basket memory 121 has areas for storing a user ID, one or a plurality of order commodity data, one or a plurality of purchased commodity data, a discount total amount, a total amount, and a settlement barcode. The order commodity data is registered in the order file 31 by the purchaser, who comes to the actual store, operating the user terminal 3 in advance to access the virtual store and ordering the commodity.

The purchased commodity data includes a commodity identification code, a commodity name, a price, a sales quantity, a sales amount, a tax amount, etc. of the purchased commodity the purchaser purchases in the actual store. The discount total amount is the sum of a discount amount generated in the transaction with the purchaser. The total amount is obtained by subtracting the discount total amount from the sum of the sales amount and the tax amount included in the purchased commodity data. The settlement barcode is a barcode of a unique settlement code generated for each transaction for identifying the transaction with the purchaser.

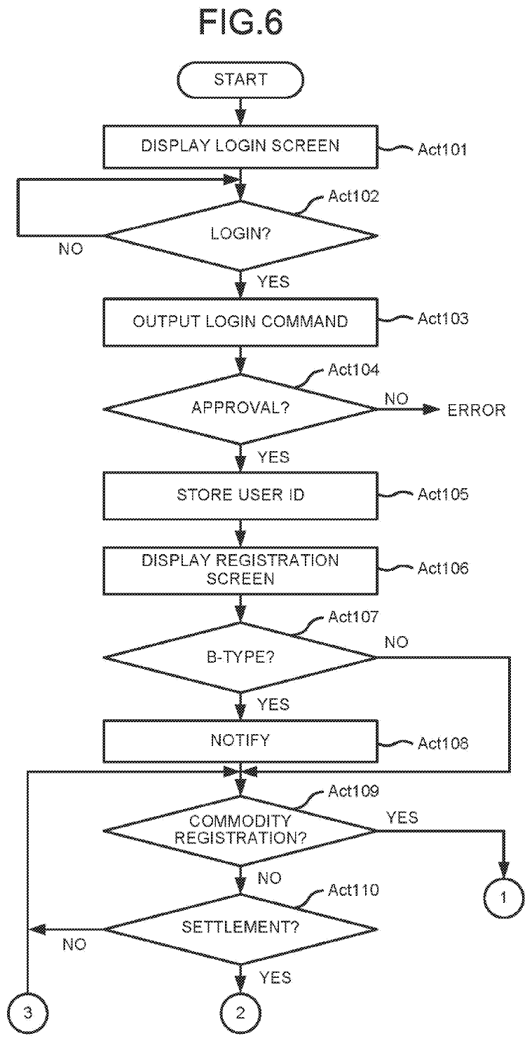

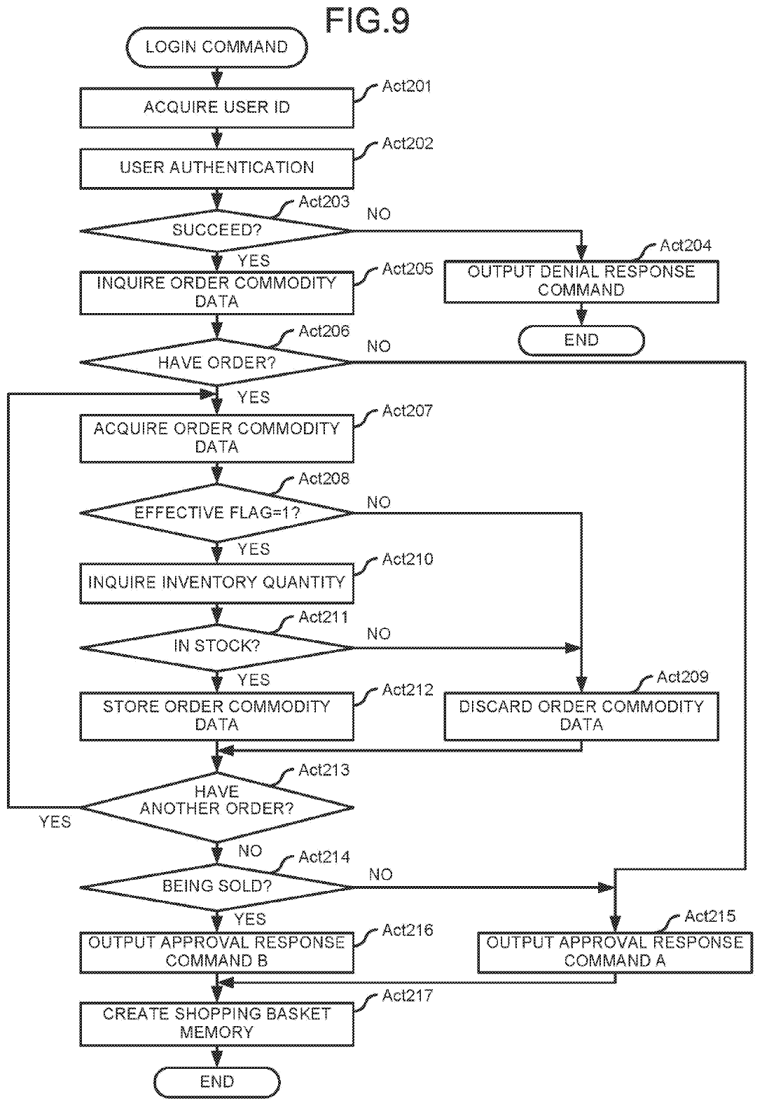

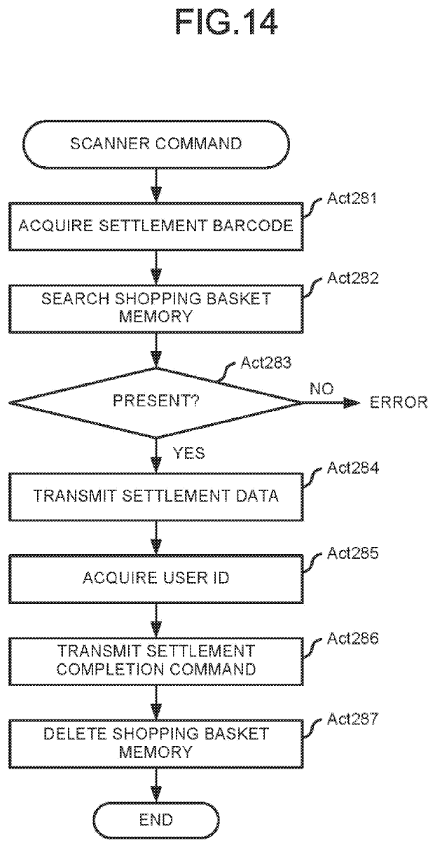

FIG. 6 to FIG. 8 are flowcharts depicting main procedures of information processing performed by the processor 61 of the information terminal 60 according to the terminal program. FIG. 9 to FIG. 13 are flowcharts depicting main procedures of information processing performed by the processor 11 of the actual store server 10 in response to reception of main commands transmitted from the information terminal 60. The procedure is in accordance with the control program. FIG. 14 is a flowchart depicting a procedure of an information processing executed by the processor 11 of the actual store server 10 in response to reception of a scanner command transmitted from the checkout device 50. The procedure is also in accordance with the control program.

Main operations of the sales system 1 are described below with reference to these flowcharts. Specifically, the purchaser, who purchases a commodity ordered in the virtual store after confirming the commodity in the actual store, registers the purchased commodity with the information terminal 60 mounted on the cart C, and performs operations to cause the settlement with the checkout device 50. The content of the operations described below is merely an example. The procedure is not particularly limited as long as the same results can be achieved.

<Operation Relating to Login>

The purchaser, who comes to the actual store, takes out the cart C from a cart storage space, and touches the touch panel 65 of the information terminal 60 mounted on the cart C. In the information terminal 60, if the touch panel 65 is touched, the processor 61 in the idle state is started. Then, the processor 61 starts the information processing with the procedure shown in the flowchart in FIG. 6.

First, the processor 61 controls the touch panel 65 to display a login screen in Act 101. The login screen is used for receiving a login operation. For example, the purchaser holds a recording medium in which a user ID is recorded. The recording medium is the user terminal 3 such as a smartphone. The recording medium may be a card medium such as an IC card or a magnetic card. In a case in which the recording medium is the user terminal 3, the user ID is displayed on a display device of the user terminal 3 in a form of a barcode or a two-dimensional data code through the execution of the application program installed in the user terminal 3. After confirming the login screen, the purchaser uses the scanner 66 to read the user ID displayed on the display device of the user terminal 3. If the user ID is read by the scanner 66, the user ID is transmitted to the processor 61 of the information terminal 60. In a case in which the recording medium is the card medium, the purchaser enables the reader 67 to read data in the card medium. If the data in the card medium is read by the reader 67, the user ID contained in the data in the card medium is transmitted to the processor 61.

After displaying the login screen, the processor 61 stands by until the login operation is performed in Act 102. If it is determined that the login operation is performed, the processor 61 follows the Yes path in Act 102 and proceeds to the processing in Act 103. The processor 61 controls the wireless unit 64 to output a login command to the actual store server 10 in Act 103. Under this control, the wireless unit 64 transmits the login command in a wireless manner. The login command is received by the access point 70, and then is transmitted to the actual store server 10 via the network 80. The login command includes the user ID input through the login operation.

If the processor 11 of the actual store server 10 receives a command from the information terminal 60 through the communication interface 14, the processor 11 confirms the type of the command. If the received command is the login command, the processor 11 starts a login command reception processing with the procedure shown in the flowchart in FIG. 9.

The processor 11 acquires the user ID from the login command in Act 201. The processor 11 authenticates the user identified by the user ID in Act 202. Specifically, the processor 11 makes an inquiry to the database server 40 about whether or not a member record including the user ID is present in the member database 43. As a result, if a response indicating that the corresponding member record is present in the member database 43 is received from the database server 40, the processor 11 determines that the user authentication succeeds. If a response indicating that no corresponding member record is present in the member database 43 is received from the database server 40, the processor 11 determines that the user authentication fails.

After performing the user authentication, the processor 11 determines the authentication result in Act 203. Here, if the authentication result indicates failure, the processor follows the No path in Act 203 and proceeds to the processing in Act 204. The processor 11 controls the communication interface 14 to output a denial response command to the information terminal 60 that transmits the login command in Act 204. Under this control, the communication interface 14 transmits the denial response command to the network 80. The denial response command is transmitted in a wireless manner from the access point 70 via the network 80, and is received by the information terminal 60 that transmits the login command. Thus, the processor 11 terminates the login command reception processing if the user authentication fails.

If the authentication result succeeds, the processor 11 follows the Yes path in Act 203 and proceeds to the processing in Act 205. The processor 11 makes an inquiry to the order server 30 about whether or not an order commodity data 311P including the user ID acquired from the login command is present in Act 205. Hereinafter, the order commodity data 311 including the user ID acquired from the login command is referred to as the order commodity data 311P.

In response to the inquiry, the order server 30 searches the order file 31 to determine whether or not the inquired order commodity data 311P is present. Then, the order server 30 transmits a determination result to the actual store server 10.

After inquiring the order server 30, the processor 11 of the actual store server 10 waits for the determination result from the order server 30 in Act 206. As a result, if a response indicating that the order commodity data 311P is not present is received, the processor 11 follows the No path in Act 206 and proceeds to the processing in Act 215. The processing in Act 215 is described below.

If a response indicating that the order commodity data 311P is present is received, the processor 11 follows the Yes path in Act 206 and proceeds to the processing in Act 207. The processor 11 acquires one order commodity data 311P from the order server 30 in Act 207. Then, the processor 11 checks an effective flag included in the order commodity data 311P in Act 208. If the effective flag is reset to “0”, the order commodity data 311P is ineffective. In this case, the processor 11 follows the No path in Act 208 and proceeds to the processing in Act 209. The processor 11 discards the order commodity data 311P in Act 209.

If the effective flag included in the order commodity data 311P is set to “1”, the processor 11 follows the Yes path in Act 208 and proceeds to the processing in Act 210. The processor 11 makes an inquiry to the database server 40 about an inventory quantity of the commodity identified by the order commodity code included in the order commodity data 311P in Act 210. In response to the inquiry, the database server 40 searches the inventory database 42. Then, the inventory quantity is obtained from an inventory record including the order commodity code as the commodity identification code, and then is notified to the actual store server 10.

After acquiring the inventory quantity, the processor 11 of the actual store server 10 determines whether or not the inventory quantity is equal to or greater than the order quantity included in the order commodity data 311P in Act 211. If the inventory quantity is smaller than the order quantity, there is not enough stock for the quantity of ordered commodities in the actual store. In this case, the processor 11 follows the No path in Act 211 and proceeds to the processing in Act 209. Specifically, the processor 11 discards the order commodity data 311P.

If the inventory quantity is equal to or greater than the order quantity, there is enough stock for the quantity of ordered commodities in the actual store. In this case, the processor 11 follows the Yes path in Act 211 and proceeds to the processing in Act 212. The processor 11 stores the order commodity data 311P in a temporary storage buffer of the main memory 62 in Act 212.

After terminating the processing in Act 209 or Act 212, the processor 11 determines whether or not another corresponding order commodity data 311P is present in the order file 31 in Act 213. If the another corresponding order commodity data 311P is present, the processor 11 follows the Yes path in Act 213 and returns to the processing in Act 207. Then, the processor 11 acquires new order commodity data 311P, and executes the processing in Act 208 to Act 212 described above again.

As described above, if a plurality of order commodity data 311P is present in the order file 31, the processor 11 performs the processing in Act 208 to Act 212 for all the order commodity data 311P. If it is determined that all of the order commodity data 311P in the order file 31 is already processed, the processor 11 follows the No path in Act 213 and proceeds to the processing in Act 214. The processor 11 determines whether or not the order commodity is being sold in Act 214. Specifically, the processor 11 determines that the order commodity is being sold if at least one order commodity data 311P is stored in the temporary storage buffer. If no order commodity data 311P is stored in the temporary storage buffer, the processor 11 determines that no order commodity is being sold.

If no order commodity is being sold, the processor 11 follows the No path in Act 214 and proceeds to the processing in Act 215. The processor 11 controls the communication interface 14 to output an A-type approval response command to the information terminal 60 that transmits the login command in Act 215. Under this control, the communication interface 14 transmits the A-type approval response command to the network 80. The A-type approval response command includes the user ID acquired from the login command. The A-type approval response command is transmitted in a wireless manner from the access point 70 via the network 80, and is received by the information terminal 60 that transmits the login command.

If the order commodity is being sold, the processor 11 follows the Yes path in Act 214 and proceeds to the processing in Act 216. The processor 11 controls the communication interface 14 to output a B-type approval response command to the information terminal 60 that transmits the login command in Act 216. Under this control, the communication interface 14 transmits the B-type approval response command to the network 80. The B-type approval response command includes the user ID acquired from the login command and the order commodity data 311 held in the temporary storage buffer. The B-type approval response command is transmitted in a wireless manner from the access point 70 via the network 80, and is received by the information terminal 60 that transmits the login command.

If the processor 11 controls the output of the A-type approval response command or the B-type approval response command, the processor 11 creates the shopping basket memory 121 in the predetermined area of the main memory 12 in Act 217. The processor 11 records the user ID acquired from the login command in the shopping basket memory 121. If the order commodity data 311P is held in the temporary storage buffer, the processor 11 records the order commodity data 311P in the shopping basket memory 121. The processor 11 then deletes the order commodity data 311P held in the temporary storage buffer.

Thus, the processor 11 terminates the login command reception processing if the user authentication succeeds.

Returning again to the description of FIG. 6, the processor 61 of the information terminal 60 that controls the output of the login command in Act 103 waits for a response command from the actual store server 10 in Act 104. If the denial response command is received from the actual store server 10, the processor 61 follows the No path in Act 104 and determines that an error occurs in the login.

If an error occurs in the login, the purchaser who is an operator of the information terminal 60 performs an error cancel operation through the touch panel 65. If the cancel operation is performed, the processor 61 resumes the processing from Act 1. Therefore, the purchaser performs the login again.

If the processor 61 receives the A-type approval response command or the B-type approval response command from the actual store server 10, the processor 61 determines Yes in Act 104 and proceeds to the processing in Act 105. The processor 61 stores the user ID included in the approval response command in the main memory 62 in Act 105. The processor 61 displays a registration screen on the touch panel 65 in Act 106. The registration screen displays a total amount and a purchased commodity list including a commodity name, a quantity, a price and the like of the commodity purchased by the purchaser.

The processor 61 determines whether the approval response command is the A-type approval response command or the B-type approval response command in Act 107. If the approval response command is the B-type approval response command, the processor 61 follows the Yes path in Act 107 and proceeds to the processing in Act 108. In Act 108, based on the order commodity data 311 included in the approval response command, the processor 61 performs a notification operation for notifying the purchaser that the order commodity is being sold in the actual store. The notification operation is performed through the registration screen.

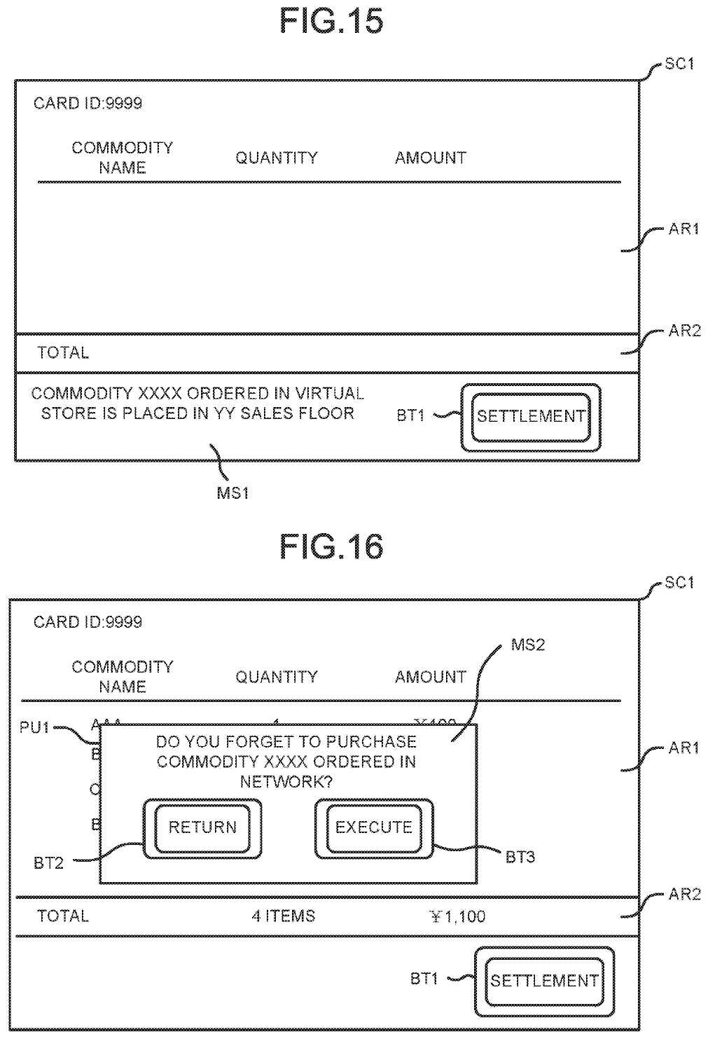

FIG. 15 shows a registration screen SC1 on which a notification operation is performed. As shown in FIG. 15, the registration screen SC1 includes a purchased commodity list display area AR1 and a total display area AR2. An image of a settlement button BT1 is displayed on a part of the registration screen SC1. The settlement button BT1 is operated when the purchaser instructs the settlement.

A message MS1 is displayed on a part of the registration screen SC1 in response to the notification operation in Act 108. The message MS1 has content for notifying the purchaser that the order commodity is being sold in the actual store. Incidentally, if a plurality of order commodity data 311 is included in the approval response command, the message MS1 is displayed for each order commodity. The messages MS1 may be displayed in order or may be scroll displayed.

The content of the message MS1 is not particularly limited. In the present embodiment, the message MS1 has content for notifying a sales floor in which the commodity ordered in the virtual store is being sold. Therefore, the purchaser who confirms the message MS1 can easily know that the commodity ordered in the virtual store is being sold in the actual store and can further know the sales floor at which the commodity is being sold.

After terminating the processing in Act 108, the processor 61 proceeds to the processing in Act 109. If the A-type approval response command is received, the processor 61 follows the No path in Act 107, skips the processing in Act 108, and proceeds to the processing in Act 109.

The processor 61 determines whether or not a commodity registration is performed in Act 109. If the commodity registration is not performed, the processor 61 follows the No path in Act 109 and proceeds to the processing in Act 110. The processor 61 determines whether or not the settlement button BT1 is operated in Act 110. If the settlement button BT1 is not operated, the processor 61 follows the No path in Act 110 and returns to the processing in Act 109. Here, the processor 61 stands by until the commodity registration is performed in Act 109 or the settlement button BT1 is operated in Act 110.

<Operation Relating to Purchased Commodity Registration>

After confirming that the registration screen SC1 is displayed on the touch panel 65 of the information terminal 60, the purchaser ventures around the sales floor to put a so-called purchased commodity, i.e., the commodity to be purchased, in the cart C. At this time, the purchaser uses the scanner 66 to read the code symbol attached to the purchased commodity before putting the purchased commodity in the cart C. When the code symbol is read by the scanner 66, the community identification code indicated by the code symbol is input to the information terminal 60. In other words, the commodity identified by the community identification code is registered.

Some commodities such as fresh food may not have the code symbols attached thereto. In a case in which no code symbol is attached to the purchased commodity, the purchaser touches a commodity button corresponding to the purchased commodity among the commodity buttons displayed on the touch panel 65. If the commodity button is touched, the commodity identification code for identifying the commodity corresponding to the commodity button is input to the information terminal 60. In other words, the commodity identified by the community identification code is registered.

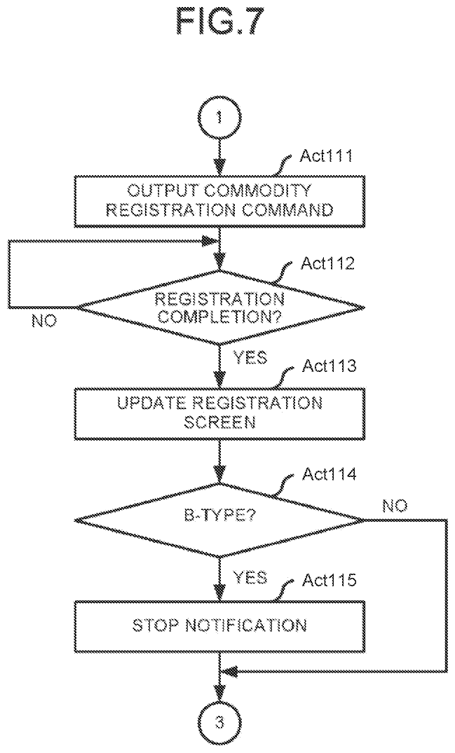

If the processor 61 of the information terminal 60 determines that the commodity registration is performed in a standby state in Act 109 and Act 110, the processor 61 follows the Yes path in Act 109 and proceeds to the processing in Act 111 in FIG. 7. The processor 61 controls the wireless unit 64 to output a commodity registration command to the actual store server 10 in Act 111. Under this control, the wireless unit 64 transmits the commodity registration command in a wireless manner. The commodity registration command includes the user ID stored in the processing in Act 105 and the commodity identification code of the registered commodity. The commodity registration command is received by the access point 70, and then is transmitted to the actual store server 10 via the network 80.

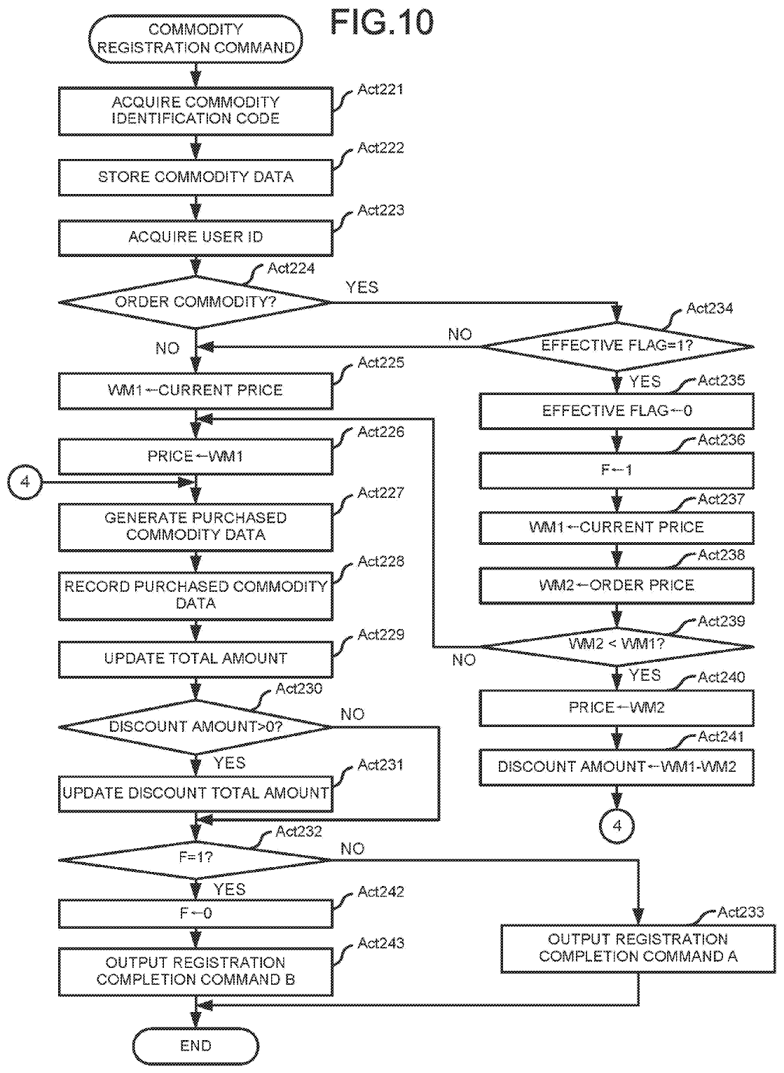

If the processor 11 of the actual store server 10 determines that the command received via the communication interface 14 is the commodity registration command, the processor 11 starts a command reception processing with the procedure shown in the flowchart in FIG. 10.

The processor 11 acquires the commodity identification code from the commodity registration command in Act 221. The processor 11 makes an inquiry to the database server 40 about the commodity data of the commodity identified by the community identification code in Act 222. In response to the inquiry, the database server 40 searches the commodity database 41 to read out the commodity data such as a price, a commodity name and the like recorded in the commodity record including the commodity identification code. The commodity data is transmitted from the database server 40 to the actual store server 10. The processor 11 of the actual store server 10 stores the commodity data transmitted from the database server 40 in a temporary storage memory.

The processor 11 acquires the user ID from the commodity registration command in Act 223. The processor 11 makes an inquiry to the order server 30 about whether or not order commodity data 311Q including the user ID acquired from the commodity registration command and the commodity identification code is registered in the order file 31 in Act 224. Hereinafter, the order commodity data 311 including the user ID acquired from the commodity registration command and the commodity identification code is referred to as the order commodity data 311Q.

After receiving the inquiry, the order server 30 searches the order file 31. If no order commodity data 311Q is detected, the order server 30 transmits a response indicating that no order commodity is present to the actual store server 10. On the other hand, if the order commodity data 311Q is detected from the order file 31, the order server 30 transmits a response indicating that the order commodity is present to the actual store server 10. The response indicating that the order commodity is present includes the order commodity data 311Q.

If the response indicating that no order commodity is present is received as a result of the inquiry to the order server 30, the processor 11 follows the No path in Act 224 and proceeds to the processing in Act 225. The processor 11 stores the price in the commodity data stored in the temporary storage memory in a first work memory WM1 in Act 225. The first work memory WM1 is formed in the volatile memory area of the main memory 12. After terminating the processing in Act 225, the processor 11 transmits data of the price stored in the first work memory WM1 to a price memory in Act 226. The price memory is formed in the volatile memory area of the main memory 12.

The processor 11 generates purchased commodity data based on the commodity data stored in the temporary storage memory in Act 227. The processor 11 records the purchased commodity data in the shopping basket memory 121 including the user ID acquired from the commodity registration command in Act 228. The processor 11 updates the total amount in the shopping basket memory 121 so as to be an amount obtained by adding the price of the purchased commodity data in Act 229.

The processor 11 determines whether or not the discount amount in a discount amount memory is greater than “0” in Act 230. The discount amount memory is formed in the volatile memory area of the main memory 12. If no order commodity data 311Q is registered in the order file 31, the discount amount in the discount amount memory is “0”. Thus, the processor 11 follows the No path in Act 230, skips the processing in Act 231 and proceeds to the processing in Act 232.

The processor 11 determines whether or not an order commodity flag F is set to “1” in Act 232. The order commodity flag F is 1-bit data stored in the volatile memory area of the main memory 12. The order commodity flag F is set to “1” when the order commodity data 311Q is registered in the order file 31, and is set to “0” when no order commodity data 311Q is registered.

If the order commodity flag F is not set to “1”, the processor 11 follows the No path in Act 232 and proceeds to the processing in Act 233. The processor 11 controls the communication interface 14 to output an A-type registration completion command to the information terminal 60 that transmits the commodity registration command in Act 233. Under this control, the communication interface 14 transmits the A-type registration completion command to the network 80. The A-type registration completion command includes a purchased commodity list, a discount total amount and a total amount. The purchased commodity list is generated from the purchased commodity data stored in the shopping basket memory 121 including the user ID acquired from the commodity registration command. The A-type registration completion command is transmitted in a wireless manner from the access point 70 via the network 80, and is received by the information terminal 60 that transmits the commodity registration command. As described above, the processor 11 terminates the commodity registration command reception processing corresponding to a case in which no order commodity is present.

In Act 224, if a response indicating that the order commodity is present is received as the result of the inquiry to the order server 30, the processor 11 follows the Yes path in Act 224 and proceeds to the processing in Act 234. The processor 11 checks the effective flag included in the order commodity data 311Q included in the response in Act 234. Here, if the effective flag is “0”, the processor 11 follows the No path in Act 234 and proceeds to the processing in Act 225 described above. Then, the processor 11 executes the processing from Act 225 to Act 233 in the same manner as described above, and then terminates the commodity registration command reception processing.

If the effective flag is “1”, the processor 11 follows the Yes path in Act 234 and proceeds to the processing in Act 235. The processor 11 instructs the order server 30 to change the effective flag included in the order commodity data 311Q to “0” in Act 235. After receiving the command, the order server 30 changes the effective flag included in the corresponding order commodity data 311Q to “0”.

The processor 11 sets the order commodity flag F to “1” in Act 236. The processor 11 stores the price in the commodity data stored in the temporary storage memory in the first work memory WM1 in Act 237. The processor 11 stores the order price in the order commodity data stored in the temporary storage memory in a second work memory WM2 in Act 238. The second work memory WM2 is formed in the volatile memory area of the main memory 12.

The processor 11 compares the price stored in the first work memory WM1 with the order price stored in the second work memory WM2 in Act 239. As a result of the comparison, if the order price stored in the second work memory WM2 is equal to or higher than the price stored in the first work memory WM1, the processor 11 follows the No path in Act 239 and returns to the processing in Act 226 described above. Then, the processor 11 executes the processing from Act 226 to Act 232 in the same manner as described above.

In this case, the processor 11 follows the Yes path in Act 232 and proceeds to the processing in Act 242. The processor 11 resets the order commodity flag F to “0” in Act 242. The processor 11 controls the communication interface 14 to output a B-type registration completion command to the information terminal 60 that transmits the commodity registration command in Act 243. Under this control, the communication interface 14 transmits the B-type registration completion command to the network 80. The B-type registration completion command includes a purchased commodity list, an order commodity code included in the order commodity data 311Q, a discount total amount and a total amount. The purchased commodity list is generated from the purchased commodity data stored in the shopping basket memory 121 including the user ID acquired from the commodity registration command. The B-type registration completion command is transmitted in a wireless manner from the access point 70 via the network 80, and is received by the information terminal 60 that transmits the commodity registration command.

On the other hand, if the order price stored in the second work memory WM2 is lower than the price stored in the first work memory WM1 as a result of comparing the price stored in the first work memory WM1 and the order price stored in the second work memory WM2, the processor 11 follows the Yes path in Act 239 and proceeds to the processing in Act 240. The processor 11 transmits data of the order price stored in the second work memory WM2 to the price memory in Act 240. The processor 11 calculates a discount amount by subtracting the order price stored in the second work memory WM2 from the price stored in the first work memory WM1, and stores the discount amount in the discount amount memory in Act 241.

After terminating the processing in Act 240 and Act 241, the processor 11 proceeds to the processing in Act 227. Then, the processor 11 executes the processing in Act 227 to Act 232, Act 242 and Act 243 in the same manner as described above. Thus, the processor 11 terminates the commodity registration command reception processing corresponding to a case in which the order commodity is present.

Returning again to the description of FIG. 7, the processor 61 of the information terminal 60 that controls the output of the commodity registration command in Act 111 waits for the registration completion command in Act 112. If the registration completion command is received from the actual store server 10, the processor 61 follows the Yes path in Act 112 and proceeds to the processing in Act 113. The processor 61 updates the registration screen SC1 displayed on the touch panel 65 in Act 113. Specifically, the processor 61 updates the registration screen SC1 so that the purchased commodity list included in the registration completion command is displayed in an area A1 of the registration screen SC1. The processor 61 updates the registration screen SC1 so that the total amount included in the registration completion command is displayed in an area A2 of the registration screen SC1.

Thereafter, the processor 61 determines whether the registration completion command is the A-type registration completion command or the B-type registration completion command in Act 114. If the registration completion command is the A-type registration completion command, the processor 61 follows the No path in Act 114 and returns to the standby state in Act 109 and Act 110 in FIG. 6.

On the other hand, if the registration completion command is the B-type registration completion command, the processor 61 follows the Yes path in Act 114 and proceeds to the processing in Act 115. The processor 61 stops the notification operation for the commodity identified by the order commodity code included in the registration completion command. Specifically, the processor 61 deletes the message MS1. Thereafter, the processor 61 returns to the standby state in Act 109 and Act 110 in FIG. 6.

<Operation Relating to Completion of Purchased Commodity Registration>

The purchaser who finishes shopping operates the settlement button BT1 on the registration screen SC1 displayed on the touch panel 65 of the information terminal 60 to perform the settlement.

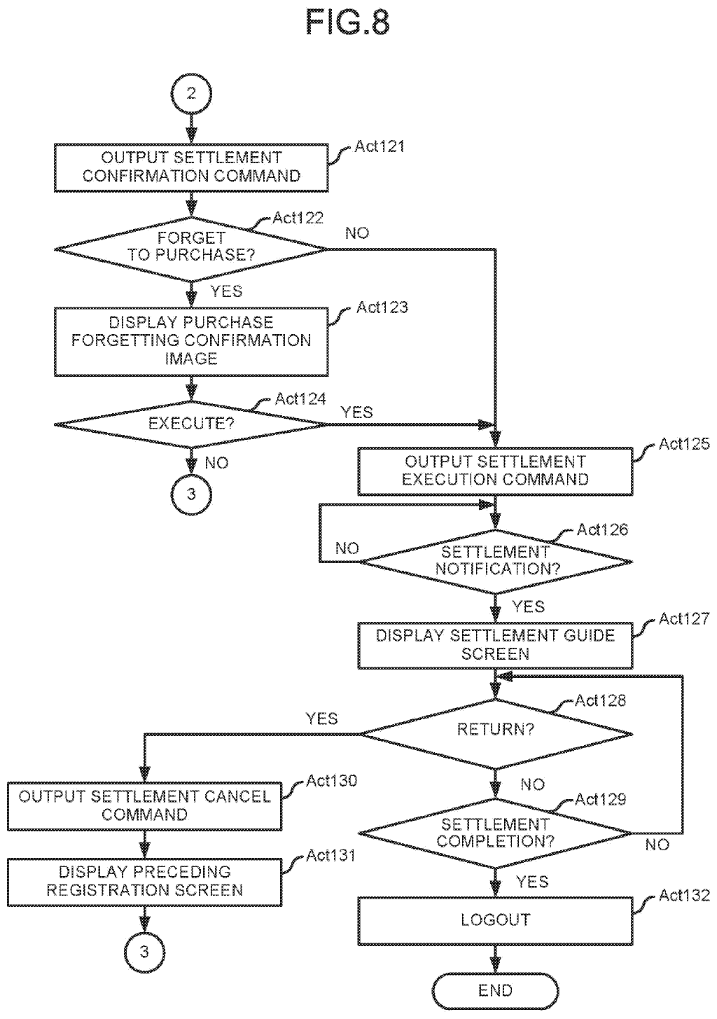

When the processor 61 of the information terminal 60 detects that the settlement button BT1 is operated in the standby state in Act 109 and Act 110, the processor 61 follows the Yes path in Act 110 and proceeds to the processing in Act 121 in FIG. 8. The processor 61 controls the wireless unit 64 to output a settlement confirmation command to the actual store server 10 in Act 121. Under this control, the wireless unit 64 transmits the settlement confirmation command in a wireless manner. The settlement confirmation command includes the user ID stored in the processing in Act 105. The settlement confirmation command is received by the access point 70, and then is transmitted to the actual store server 10 via the network 80.

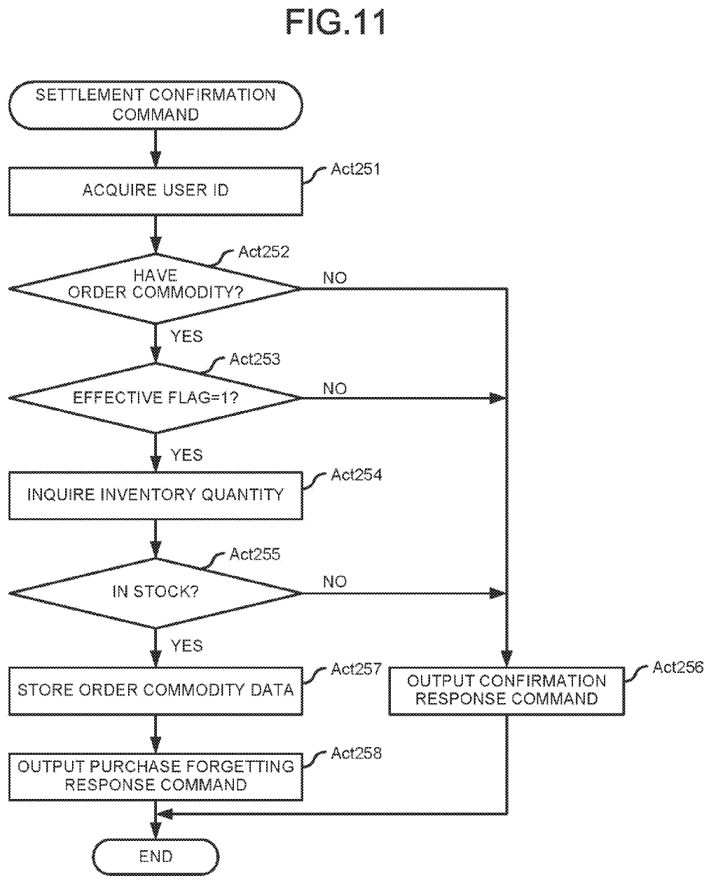

If the processor 11 of the actual store server 10 determines that the command received via the communication interface 14 is the settlement confirmation command, the processor 11 starts a command reception processing with the procedure shown in the flowchart in FIG. 11.

The processor 11 acquires the user ID from the settlement confirmation command in Act 251. Then, the processor 11 makes an inquiry to the order server 30 about whether or not order commodity data 311R including the user ID acquired from the settlement confirmation command is registered in the order file 31 in Act 252. Hereinafter, the order commodity data 311 including the user ID acquired from the settlement confirmation command is referred to as the order commodity data 311R.

After receiving the inquiry, the order server 30 searches the order file 31. If no order commodity data 311R is detected, the order server 30 transmits a response indicating that no order commodity is present to the actual store server 10. On the other hand, if the order commodity data 311R is detected from the order file 31, the order server 30 transmits a response indicating that the order commodity is present to the actual store server 10. The response indicating that the order commodity is present includes the order commodity data 311R.

If the response indicating that no order commodity is present is received as the result of the inquiry to the order server 30, the processor 11 follows the No path in Act 252 and proceeds to the processing in Act 256. The processor 11 controls the communication interface 14 to output a confirmation response command to the information terminal 60 that transmits the settlement confirmation command in Act 256. Under this control, the communication interface 14 transmits the confirmation response command to the network 80. The confirmation response command includes the user ID acquired from the settlement confirmation command. The confirmation response command is transmitted in a wireless manner from the access point 70 via the network 80, and is received by the information terminal 60 that transmits the settlement confirmation command. As described above, the processor 11 terminates the settlement confirmation command reception processing corresponding to a case in which no order commodity is present for the settlement confirmation command containing the user ID of the user.

If a response indicating that the order commodity is present is received as the result of the inquiry to the order server 30, the processor 11 follows the Yes path in Act 252 and proceeds to the processing in Act 253. The processor 11 checks the effective flag included in the order commodity data 311R included in the response in Act 253. If the effective flag is “0”, the processor 11 follows the No path in Act 253, and proceeds to the processing in Act 256 described above. Then, the processor 11 executes the processing in Act 256 in the same manner as described above, and terminates the settlement confirmation command reception processing.

If the effective flag is “1”, the processor 11 follows the Yes path in Act 253, and proceeds to the processing in Act 254. The processor 11 makes an inquiry to the database server 40 about the inventory quantity of the commodity identified by the order commodity code included in the order commodity data 311 in Act 254. In response to the inquiry, the database server 40 searches the inventory database 42. The inventory quantity is obtained from the inventory record including the order commodity code as the commodity identification code, and then is notified to the actual store server 10.

After inquiring the inventory quantity, the processor 11 of the actual store server 10 determines whether or not the inventory quantity notified from the database server 40 is equal to or greater than the order quantity included in the order commodity data 311R in Act 255. If the inventory quantity is smaller than the order quantity, the processor follows the No path in Act 255, and proceeds to the processing in Act 256 described above. The processor 11 executes the processing in Act 256 in the same manner as described above, and then terminates the settlement confirmation command reception processing.

If the inventory quantity is equal to or greater than the order quantity, the processor 11 follows the Yes path in Act 255 and proceeds to the processing in Act 257. The processor 11 stores the order commodity data 311R in the temporary storage buffer of the main memory 62 in Act 257. The processor 11 controls the communication interface 14 to output a purchase forgetting response command to the information terminal 60 that transmits the settlement confirmation command in Act 258. Under this control, the communication interface 14 transmits the purchase forgetting response command to the network 80. The purchase forgetting response command includes the user ID acquired from the settlement confirmation command and the order commodity data 311R held in the temporary storage buffer. The purchase forgetting response command is transmitted in a wireless manner from the access point 70 via the network 80, and is received by the information terminal 60 that transmits the settlement confirmation command. Thus, the processor 11 terminates the settlement confirmation command reception processing corresponding to a case in which the order commodity is present for the settlement confirmation command containing the user ID of the user.

Returning again to the description of FIG. 8, the processor 61 of the information terminal 60 that controls the output of the settlement confirmation command in Act 121 waits for a response command in Act 122. If the confirmation response command is received from the actual store server 10, the processor 61 follows the No path in Act 122 and proceeds to the processing in Act 125. The processing in Act 125 is described below.

If the purchase forgetting response command is received from the actual store server 10, the processor 61 follows the Yes path in Act 122 and proceeds to the processing in Act 123. The processor 61 displays a purchase forgetting confirmation image PU1 (refer to FIG. 16) by superimposing it on the registration screen SC1 in Act 123.

FIG. 16 is a diagram schematically illustrating an example of the purchase forgetting confirmation image PU1. On the purchase forgetting confirmation image PU1, a message MS2 for inquiring the purchaser about whether or not he/she forgets to purchase the commodity indicated by the order commodity data 311R included in the purchase forgetting response command, and images of a return button BT2 and an execution button BT3 are displayed. The return button BT2 is operated when the purchaser interrupts the settlement and returns to the commodity registration. The execution button BT3 is operated when the purchaser executes the settlement without interruption.

The content of the message MS2 displayed in FIG. 16 is merely an example of the message MS2. The message MS2 may include any content as long as it is used to inquire the purchaser about whether or not he/she forgets to purchase the commodity ordered in the virtual store.

When the purchaser who confirms the purchase forgetting confirmation image PU1 interrupts the settlement and returns to the commodity registration, he/she touches the return button BT2. When the purchaser executes the settlement without interruption, he/she touches the execution button BT3.

After controlling the display of the purchase forgetting confirmation image PU1, the processor 61 stands by until the execution button BT3 is operated or the return button BT2 is operated in Act 124. If the return button BT2 is operated, the processor 61 follows the No path in Act 124, and returns to the processing in Act 109 in FIG. 6. Then, the processor 61 enters a standby state in Act 109 and Act 110.

If the execution button BT3 is operated, the processor follows the Yes path in Act 124 and proceeds to the processing in Act 125. Specifically, if the processor 61 receives the confirmation response command from the actual store server 10, or if the processor 61 receives the purchase forgetting response command but the execution button BT3 on the purchase forgetting confirmation image PU1 is operated, the processor 61 proceeds to the processing in Act 125. The processor 61 controls the wireless unit 64 to output a settlement execution command to the actual store server 10 in Act 125. Under this control, the wireless unit 64 transmits the settlement execution command in a wireless manner. The settlement execution command is received by the access point 70, and then is transmitted to the actual store server 10 via the network 80. The settlement execution command includes the user ID stored in the processing in Act 105.

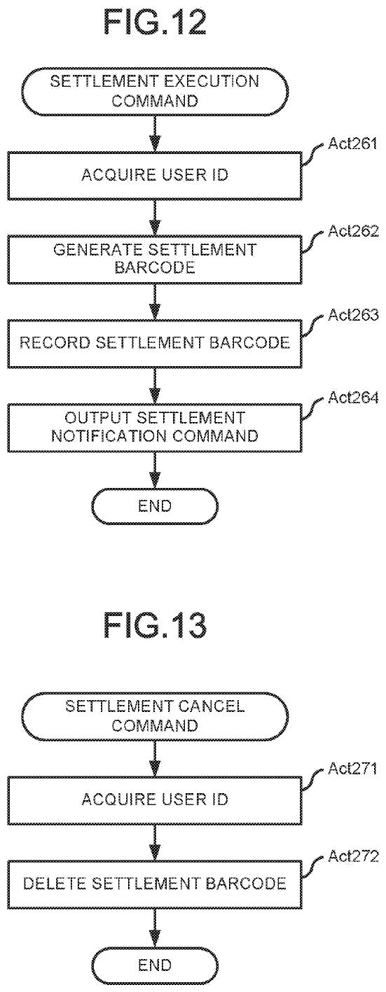

If the processor 11 of the actual store server 10 determines that the command received via the communication interface 14 is the settlement execution command, the processor 11 starts the command reception processing with the procedure shown in the flowchart in FIG. 12.

The processor 11 acquires the user ID from the settlement execution command in Act 261. The processor 11 generates a settlement barcode in Act 262. Then, the processor 11 records the settlement barcode in the shopping basket memory 121 in which the user ID acquired in the processing in Act 261 is set in Act 263.

The processor 11 controls the communication interface to output a settlement notification command to the information terminal 60 that transmits the settlement execution command in Act 264. Under this control, the communication interface 14 transmits the settlement notification command to the network 80. The settlement notification command includes the total amount and the settlement barcode stored in the shopping basket memory 121 in which the user ID acquired from the settlement execution command is recorded. The settlement notification command is transmitted in a wireless manner from the access point 70 via the network 80, and is received by the information terminal 60 that transmits the settlement execution command. Thus, the processor 11 terminates the settlement execution command reception processing.

Returning again to the description of FIG. 8, after controlling the transmission of the settlement execution command, the processor 61 waits for the settlement notification command in Act 126. If the settlement notification command is received, the processor 61 follows the Yes path in Act 126 and proceeds to the processing in Act 127. The processor 61 sets the screen on the touch panel 65 to a settlement guide screen SC2 in Act 127.

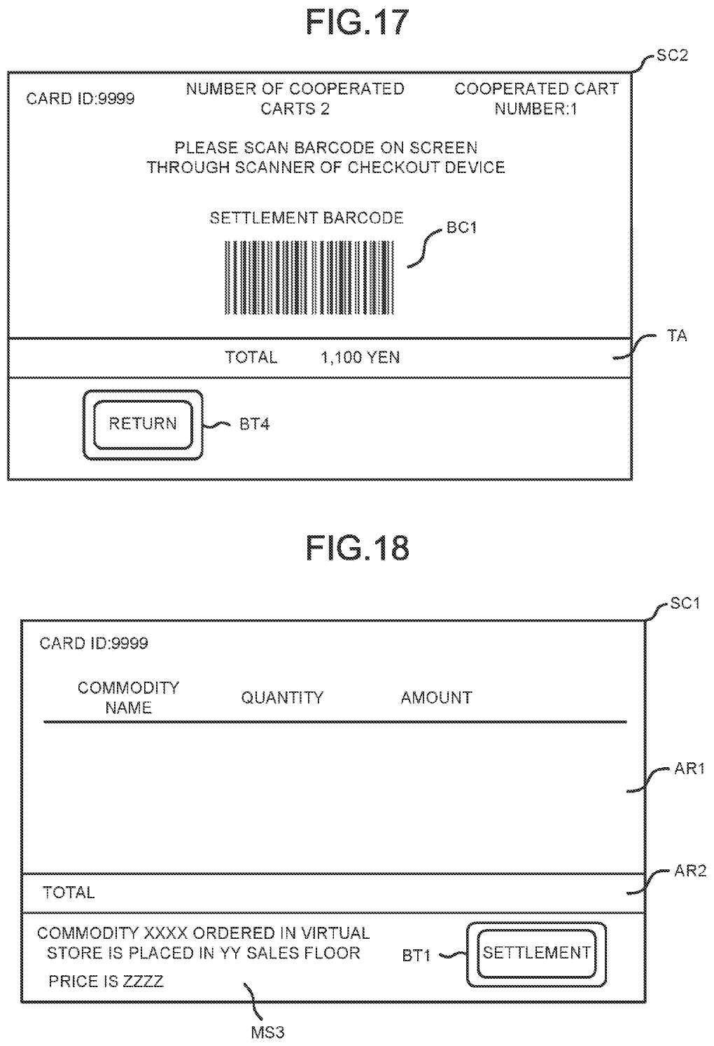

FIG. 17 shows an example of the settlement guide screen SC2. As shown in FIG. 17, a settlement barcode BC1 and a total amount TA included in the settlement notification command are displayed on the settlement guide screen SC2. An image of a [return] button BT4 is also displayed. The [return] button BT4 is operated when the purchaser instructs to stop the settlement.

After displaying the settlement guide screen SC2, the processor 61 determines whether or not the [return] button BT4 is operated in Act 128. If the [return] button BT4 is not operated, the processor 61 follows the No path in Act 128 and proceeds to the processing in Act 129. The processor 61 determines whether or not a settlement completion command is received in Act 129. The settlement completion command is described below. If the settlement completion command is not received, the processor 61 follows the No path in Act 129 and returns to the processing in Act 128. Here, the processor 61 stands by until the [return] button BT4 is operated in Act 128 or the settlement completion command is received in Act 129.

In the standby state, if it is detected that the [return] button BT4 is operated, the processor 61 follows the Yes path in Act 128 and proceeds to the processing in Act 130. The processor 61 controls the wireless unit 64 to output a settlement cancel command to the actual store server 10 in Act 130. Under this control, the wireless unit 64 transmits the settlement cancel command in a wireless manner. The settlement cancel command is received by the access point 70, and then is transmitted to the actual store server 10 via the network 80. The settlement cancel command includes the user ID acquired in the processing in Act 105.

After controlling the transmission of the settlement cancel command, the processor 61 returns the screen on the touch panel 65 to the registration screen SC1 immediately before switching to the settlement guide screen SC2 in Act 131. Thereafter, the processor 61 returns to the processing in Act 109 in FIG. 6. The processor 61 enters a standby state in Act 109 and Act 110.

If the processor 11 of the actual store server 10 determines that the command received via the communication interface 14 is the settlement cancel command, the processor 11 starts a command reception processing with the procedure shown in the flowchart in FIG. 13.

The processor 11 acquires the user ID from the settlement cancel command in Act 271. Then, the processor 11 deletes the settlement barcode from the shopping basket memory 121 including the user ID in Act 272. Thus, the processor 11 terminates the settlement cancel command reception processing.

<Operation Relating to Settlement of Purchased Commodity>

The purchaser who finishes shopping goes to a place in which the checkout device 50 is installed while pushing the cart C. The purchaser uses the scanner of the checkout device 50 to read the settlement barcode BC1 on the settlement guide screen SC2 displayed on the touch panel 65 of the information terminal 60. Then, a scanner command is transmitted from the checkout device 50 to the actual store server 10. The scanner command includes data of the settlement barcode.

After receiving the scanner command, the processor 11 of the actual store server 10 starts a processing with the procedure shown in the flowchart in FIG. 14. Specifically, the processor 11 acquires the data of the settlement barcode from the scanner command in Act 281. The processor 11 searches an area in which the shopping basket memory 121 of the main memory 12 is created with the data of the settlement barcode in Act 282.

The processor 11 determines whether or not a shopping basket memory 121P in which the data of the settlement barcode is recorded is present in Act 283. Hereinafter, the shopping basket memory 121 in which the data of the settlement barcode acquired from the scanner command is recorded is referred to as the shopping basket memory 121P.

If the shopping basket memory 121P is not present, the processor 11 follows the No path in Act 283 and determines that an error occurs in the input of the scanner command. If an error occurs in the input of the scanner command, the checkout device 50 notifies the error. The purchaser who confirms the error scans the settlement barcode again.

If the shopping basket memory 121P is present, the processor 11 follows the Yes path in Act 283 and proceeds to the processing in Act 284. The processor 11 controls the communication interface 14 to output the purchased commodity data, the discount total amount data and the total amount data recorded in the shopping basket memory 121P as settlement data required for the settlement processing to the checkout device 50 that transmits the scanner command in Act 284. Under this control, the communication interface 14 transmits the settlement data to the network 80. The settlement data is transmitted to the checkout device 50 that transmits the scanner command, and then the settlement processing is executed. Since the settlement processing is a known processing in the checkout device 50, a description thereof is omitted.

After controlling the transmission of the settlement data, the processor 11 acquires the user ID recorded in the shopping basket memory 121P in Act 285. The processor 11 controls the communication interface 14 to output the settlement completion command to the information terminal 60 that transmits the settlement execution command in Act 286. Under this control, the communication interface 14 transmits the settlement completion command to the network 80. The settlement completion command includes the user ID acquired from the shopping basket memory 121P. The settlement completion command is transmitted in a wireless manner from the access point 70 via the network 80, and is received by the information terminal 60 that transmits the settlement execution command. The processor 11 deletes the shopping basket memory 121P in Act 287. The processor 11 terminates the scanner command reception processing.

Returning again to the description of FIG. 8, if the processor 61 receives the settlement completion command in the standby state in Act 128 and Act 129, the processor 61 follows the Yes path in Act 129 and proceeds to the processing in Act 132. The processor 61 performs logout in Act 132. If the logout is terminated, the processor 61 terminates the information processing according to the terminal program.

Thus, the description of the main operations of the sales system 1 is terminated.

As can be understood from the above description, the actual store server 10 of the present embodiment comprises an acquiring module configured to acquire the order information relating to the commodity ordered in the virtual store; a specifying module configured to identify the purchaser who comes to the actual store; and a notifying module configured to notify the purchaser that the commodity is being sold on condition that the commodity is in stock in the actual store if the order information acquired by the acquiring module includes the order information relating to the commodity ordered by the purchaser identified by the specifying module. Specifically, a computer having the processor 11 of the actual store server 10 functions as the acquiring module by performing the processing in Act 205 to Act 207 in FIG. 9 according to a control program. The computer functions as the specifying module by performing the processing in Act 201 to Act 203 in FIG. 9 according to the control program. The computer functions as the notifying module by performing the processing in Act 208 to Act 216 in FIG. 9 according to the control program.

According to the sales system 1 provided with the actual store server 10 having such a configuration, the purchaser who desires a sales form in which an order is placed in the virtual store and the commodity is purchased after being seen in the actual store can easily know that the commodity ordered in the virtual store is being sold in the sales floor at the time of coming to the actual store.

The actual store server 10 includes a registration module that compares a price at the time point of ordering the purchased commodity and a price at the time point of purchasing the purchased commodity in the actual store to select the lower price and registers sales information relating to the purchased commodity in a case in which the purchased commodity to be purchased by the purchaser in the actual store is the commodity ordered by the purchaser. Specifically, the computer having the processor 11 of the actual store server 10 functions as the registration module by performing the processing in Act 221 to Act 241 in FIG. 9 according to the control program.

According to the sales system 1 provided with the actual store server 10 having such a configuration, in a case in which the order is placed in the virtual store and the commodity is purchased after being seen in the actual store, since the sales registration is performed at the lower price even if the price at the time of ordering and the price at the time of purchasing are different, the price at the time of purchasing in the actual store is not higher than that at the time of ordering in the virtual store. The price at the time of purchasing can be made lower than that at the time of ordering. In this way, the purchaser can employ the sales form in which the order is placed in the virtual store and the commodity is purchased after being seen in the actual store at ease.

The actual store server 10 identifies the purchaser based on the login information input to the information terminal 60 mounted on the cart C. The actual store server performs notification to the purchaser who uses the information terminal 60 via the information terminal 60. Therefore, the purchaser who comes to the actual store can receive a notification indicating whether or not the ordered commodity is being sold in the actual store simply by logging into the information terminal 60 mounted on the cart C.

As described above, although the embodiment of the commodity data processing apparatus capable of easily operating in a sales form in which the commodity is purchased after being seen in the actual store is described, the embodiment is not limited thereto.

The notifying module may compare the price of the commodity ordered by the purchaser at the time point of ordering with the price at the time point of purchasing in the actual store to select the lower price, and notify the purchaser that the commodity is being sold with the information of the selected price. FIG. 18 shows an example of the registration screen SC1 in this case. As shown in the FIG. 18, a message MS3 is displayed in a part of the registration screen SC1 to notify the purchaser that the order commodity is being sold in the actual store and that the price thereof is “ZZZZ”.

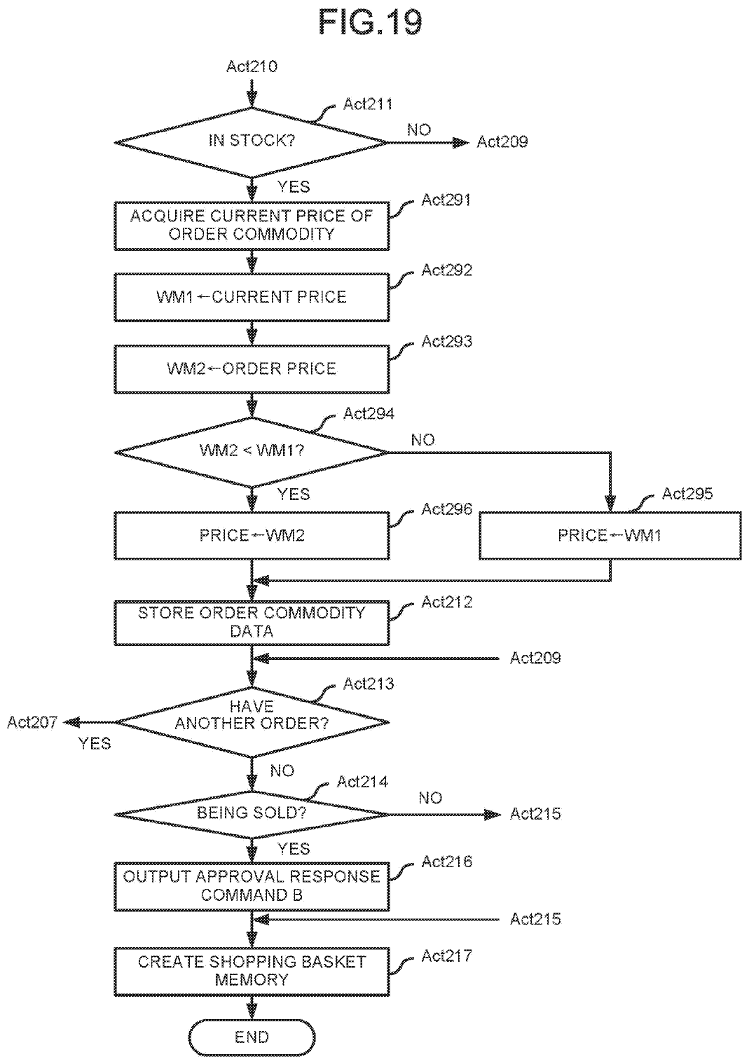

Such notification can be performed by changing a part of the login command reception processing executed by the processor 11 of the actual store server 10. FIG. 19 is a flowchart depicting main procedures of the changed login command reception processing. The same reference numerals are denoted to the processing step common with that in FIG. 9.

Specifically, the processor 11 executes the processing in Act 291 to Act 296 until the processing in Act 212 after taking Yes in Act 211.

The processor 11 makes an inquiry to the database server about the price of the commodity identified by the commodity identification code included in the order commodity data in Act 291. In response to the inquiry, the database server 40 searches the commodity database 41 to read out the price recorded in the commodity record including the commodity identification code. The database server 40 notifies the data of the price to the actual store server 10. The processor 11 of the actual store server 10 stores the data of the price notified from the database server 40 in the first work memory WM1 in Act 292.

The processor 11 stores the order price of the order commodity data stored in the temporary storage memory in the second work memory WM2 in Act 293. In Act 294, the processor 11 compares the price stored in the first work memory WM1 with the order price stored in the second work memory WM2. If the order price stored in the second work memory WM2 is equal to or higher than the price stored in the first work memory WM1 as a result of the comparison, the processor 11 follows the No path in Act 294 and proceeds to the processing in Act 295. The processor 11 transmits the data of the price stored in the first work memory WM1 to the price memory in Act 295. If the order price stored in the second work memory WM2 is lower than the price stored in the first work memory WM1, the processor 11 follows the Yes path in Act 294 and proceeds to the processing in Act 296. The processor 11 transmits the data of the price stored in the second work memory WM2 to the price memory in Act 296. Thereafter, the processor 11 proceeds to the processing in Act 212.

Thereafter, the processor 11 controls the communication interface 14 to output the B-type approval response command to the information terminal 60 that transmits the login command transmission in Act 216. At that time, the B-type approval response command includes the user ID acquired from the login command, the order commodity data 311 held in the temporary storage buffer, and the data of the price stored in the price memory. In this way, the price of the commodity ordered by the purchaser at the time point of ordering and the price at the time point of purchasing in the actual store can be compared to select the lower price, and the purchaser can be notified that the commodity is being sold with the information of the selected price.

In the embodiments described above, a case in which the actual store server 10 determines whether or not the effective flag included in the order commodity data is “1” is exemplified. This type of determination may be performed by the order server 30.

In the embodiments described above, the notifying module performs notification through the information terminal 60 mounted on the cart C. A notification destination is not limited to the information terminal 60. Instead of the information terminal 60, a communication terminal such as a smartphone carried by the purchaser may be used as the notification destination.

In the embodiments described above, a case in which the purchaser orders the commodity in the virtual store published on the website is shown, but the method of ordering the commodity is not limited thereto. For example, the purchaser may order the commodity by inputting order information to a data file in a determined input format and transmitting an e-mail attached with the data file to a predetermined e-mail address. Alternatively, the purchaser may order the commodity using a message application such as [LINE]®, WhatsApp® or the like.

In the embodiments described above, a case in which the control program is stored in the main memory 12 or the auxiliary storage device 13 in advance in the actual store server 10 is exemplified. In this respect, the commodity data processing apparatus may be configured in such a manner that the control program is not stored in the main memory 12 and the auxiliary storage device 13. In that case, a control program individually transferred to the commodity data processing apparatus may be written in a writable storage device included in the commodity data processing apparatus in response to an operation performed by the user or the like. The control program can be transferred by recording on a removable recording medium or by establishing communication via the network. The recording medium may be in any form as long as it can store a program such as a CD-ROM, a memory card or the like, and can be read by the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A shopping cart comprising:
a cart;
a terminal mounted on the cart and including a touch panel, a wireless communication interface, and a processor, the wireless communication interface being wirelessly communicable with an order server that stores an order file including one or more products that have been registered through an online store in association with a user ID and a store server of a physical store associated with the online store; and
a card reader and a scanner mounted on the cart and electrically connected to the terminal;
wherein the processor of the terminal is configured to:
upon one of the card reader and the scanner acquiring a user ID, control the wireless communication interface to transmit a login command with the obtained user ID to the store server and cause the store server to determine whether an order file stored in the order server in association with the obtained user ID includes a product in stock in the physical store; and
upon the wireless communication interface receiving from the store server a response indicating that the order file associated with the obtained ID includes the product in stock in the physical store, control the touch panel to display a message indicating that the product, registered online, is stock in the physical store.

2. The shopping cart according to claim 1, wherein the message also indicates an online price of the product at online registration when the online price is less than a store price of the product, and indicates the store price when the store price is less than the online price.

3. The shopping cart according to claim 1, wherein the message also indicates a sales location of the product in the physical store.

4. The shopping cart according to claim 1, wherein
the processor is further configured to control the touch panel to display a screen including a product registration list based on product codes read by the scanner, and
the message is included in the screen.

5. The shopping cart according to claim 4, wherein
the processor is further configured to, upon a predetermined user operation in a state where the product registered online is not included in the product registration list, control the touch panel to display a second message indicating that the product registered online has not been included in the product registration list.

6. The shopping cart according to claim 5, wherein the predetermined user operation includes a user operation to proceed to settlement.

7. The shopping cart according to claim 6, wherein the screen includes a selectable object that triggers the user operation to proceed to settlement.

8. The shopping cart according to claim 5, wherein the second message is overlaid on the product registration list.
